(19) United States
(12) Patent Application Publication
(10) Pub. No.: US 2013/0057651 A1
(43) Pub. Date: Mar. 7, 2013

(54) METHOD AND SYSTEM FOR POSITIONING OF AN ANTENNA, TELESCOPE, AIMING DEVICE OR SIMILAR MOUNTED ONTO A MOVABLE PLATFORM

(71) Applicant: Gard Flemming Ueland, Trondheim (NO)

(72) Inventor: Gard Flemming Ueland, Trondheim (NO)

(73) Assignee: KONGSBERG SEATEX AS, Trondheim (NO)

(21) Appl. No.: 13/392,236

(22) PCT Filed: May 27, 2011
(86) PCT No.: PCT/NO2011/000160

§ 371 Date: Mar. 26, 2012

(30) Foreign Application Priority Data
May 28, 2010 (NO) 20100779

(51) Int. Cl. H04N 7/18; H04N 13/02

(52) U.S. Cl. 348/46; 348/135; 348/E07.085; 348/E13.074

(57) ABSTRACT

Method and system for positioning an antenna (11), telescope, aiming device or similar, arranged to a movable platform (13) in a dome (12) or a part of a dome (12), said dome (12) having an interior surface (15) and/or is provided with a screen. The method and system are arranged to arrange or provide one or more patterns (40) or rasters at an interior surface (15) of a dome (12) or a screen arranged in the dome (12), for thereupon recording and analyzing the patterns/rasters (40) to calculate the accurate position of the antenna (11), telescope, aiming device or similar, and in this way highly accurate determination of position of the aiming direction (14) of the antenna (11), telescope, aiming device or similar.

The invention is related to a method of performing highly accurate position determination of aiming direction of an antenna, a telescope, aiming device or similar, arranged on a movable platform in a dome, or a part of a dome, and hence an accurate control of the antenna, telescope, aiming device or similar, according to the preamble of claim 1. The invention is also related to a system for the same according to the preamble of claim 9.

### BACKGROUND

To maintain constant and uninterrupted communication between a fixedly mounted receiver station and a movable sender, or between a movable receiver station and a movable sender, there is a need for an antenna control system prepared to establish overlapping cover between the antenna lobes of the sender and receiver so that the communication between sender and receiver can be performed with a minimum of loss. For movable senders and receivers there is therefore a need for antennas which can be controlled both in azimuth (As) and elevation (El) so that an optimal accommodation between the antenna lobes of the sender and receiver is achieved at all times. To achieve optimal transmission, the aiming angle of the antenna (As, El) must be known and be controllable at a highest possible accuracy.

When senders and receivers in addition are mounted on movable platforms, there will be a need for a control system that is able to compensate for self-motion of the platform caused by affection from the surroundings. Onboard a vessel, one will typically have to compensate for variations in heave, roll and pitch caused by wind, waves and current conditions. An antenna platform mounted on a vehicle must in a similar manner be able to compensate for vehicle movements dependent of path and ground conditions. Moreover, the fundament or structure itself the antenna is mounted on may exhibit a self-motion due to that it is not completely rigid. If the antenna element, typically a parabolic antenna, has a large mass, the antenna carrier may move substantially when the antenna platform itself is subjected to accelerations caused by external affection.

An antenna arranged to follow a movable sender, e.g. a satellite, will usually have a control system based on the use of the receiver's automatic gain control (“AGC—Automatic Gain Control”). The AGC voltage from the receiver varies proportionally with the strength of the received signal and can therefore be used as a control signal for the antenna. Some systems have adaptive control applications which ensure antenna control with an optimal AGC signal at all times.

A satellite can also be tracked by turning the antenna system in accordance with a preprogrammed path that describes the orbit of the satellite. By combining the two methods, it is possible to provide a system which is able to follow the satellite orbit relatively close and maintain a good signal level.

The disadvantage of the AGC method is that a continuous and strong signal is required to be able to estimate the direction of the satellite. At weak signals the AGC system may easily provide wrong estimates. The AGC system is also subject to external sources of noise which may cause large errors in the position estimate. AGC controlling alone is therefore a risky strategy for controlling antennas.

Use of a preprogrammed path does also have its weaknesses. Because of naturally occurring changes in orbit parameters during the lifetime of the satellite, new paths and parameters must be programmed to keep the system within acceptable accuracy limits over time.

To compensate for self-motions of the antenna platform, gyro or other motion sensors are normally being used. These will to a certain degree provide estimates of self-motion which can be used to correct the aiming angle of the antenna.

Antennas of this type are often mounted in a dome to protect the installation against snow, ice and climatic influences. In the present invention the dome will be used for accurate estimation of aiming angle for an antenna, a telescope, aiming device or similar in a simple, accurate and appropriate way. This is not known from prior publications.

It is not known similar systems from before, but from EP 1353404 it is known a radar antenna system comprising a wheel, cone or frustum having an axis. The wheel, cone or frustum has a circumferential portion adapted to engage at least one path disposed on a platform for revolving the radar array about the platform. A radar array is mounted on the wheel, cone or frustum, with the axis normal to a face of the radar array. The wheel, cone or frustum rotates about the platform as the radar array revolves around the platform during operation. In this publication it is arranged a well-known Gray code disk to a shaft for the antenna, which Gray code disk is used to control the antenna. A large disadvantage with this solution is that it only has possibilities read the position in azimuth, and not elevation. Further, the accuracy will be limited due to the Gray code disk will have limited area.

### OBJECT

The main object of the invention is to provide a method and a system for highly accurate determination of position of aiming direction of an antenna, a telescope, aiming device or similar arranged on a movable platform in a dome or in a part of a dome, and hence accurate control of the antenna, telescope, aiming device or similar in relation to a desired target or orbit, which solves the disadvantages of prior art as mentioned above.

It is also an object of the present invention that it is to be arranged to compensate for self-motion of the platform, fundament, carrier for the antenna, telescope, aiming device or similar, in the same manner as for other movement of the antenna, telescope, aiming device or similar.

Moreover, it is an object of the invention to provide a relatively low price and more accurate solution of positioning of an antenna, a telescope, aiming device or similar in a dome.

### THE INVENTION

A method according to the invention is stated in claim 1. Advantageous features of the method are stated in claims 2-8.

A system according to the invention is stated in claim 9. Advantageous features of the system are stated in claims 9-24.

Mounting antennas, telescope, aiming devices or similar in a dome or a part of a dome provides new possibilities of estimating aiming angle of an antenna, a telescope, aiming device or similar in a simple, accurate and suitable manner. The idea of the invention is based on arranging or providing a known raster or pattern inside the dome or a screen arranged in the dome by means of one or more light sources, and use one or more r means for reading the raster/pattern, which results in that it is possible to provide a highly accurate position determination of the aiming direction of an antenna, a telescope, aiming device or similar. Moreover, this highly accurate position can be used to control the antenna, telescope, aiming device or similar in relation to desired target or orbit.

A system according to the invention for arrangement a controllable antenna, a controllable telescope, aiming device or similar arranged to a movable platform in a dome, or a part of a dome, includes at least one of the following:
one or more light sources arranged for arranging or providing one or more predefined patterns or rasters on an interior surface of the dome or a screen arranged in the dome by means of visible and/or invisible light;
a raster or pattern control unit arranged to choose between a number of relevant patterns or rasters and being connected to a control unit of the system;
a light source reference positioning unit arranged for defining a reference point on the screen or the interior surface of the dome, where the exact position of the reference point can be controlled by the raster or pattern control unit;
at least one recording means arranged to the movable antenna, telescope, aiming device or similar which move together with the latter and being arranged for stereoscopic reading of one or more patterns and/or rasters established at the interior surface of the dome or a screen arranged in the dome;
an image analyzer having different filters arranged to transform the signals from the recording means to digital signatures and parameterized presentations of the image content from each individual recoding means;
a raster or pattern recognition unit arranged for signal processing information from each individual recoding means and transfer the particular information to the control unit of the system for further processing;
a positioning control unit arranged to control the position of the antenna, telescope, aiming device or similar in azimuth and elevation via the movable platform by means of suitable motors and actuators;
position control sensors arranged to measure azimuth and elevation position for the antenna, telescope, aiming device or similar and which can provide control signals back to the position control unit and the control unit of the system;
a control unit arranged to:
   transmit and receive data to and from the raster or pattern recognition unit, the position control unit and remaining units of the system,
   perform calculations and algorithms with regard to controlling and control of the aiming angle position for the antenna, telescope, aiming device or similar, based on data from one or more of the following: the raster or pattern recognition unit, position sensors and external data related to orbit parameters, and control signals, typically AGC, from a receiver system connected to the antenna, telescope or similar, or other data sources having information for control of aiming angle position, typically GPS, Glonass or Galileo data;
a user interface arranged to serve as an operator panel and being arranged to present data and submit input data to the system.

A raster or pattern which is provided or arranged by the light source on the inside of a dome or a screen arranged in the dome can be provided:
by either horizontal or vertical lines,
by both horizontal and vertical lines,
by bar codes, characters, figures, symbols or similar graphical codes,
by lines having different properties, such as different line width, dotted, continuous, stippled etc.,
by lines which themselves form a pattern which is suitable for optical recognition, such as bar codes, characters, figures, symbols or similar graphical codes,
by using visible and/or invisible light, in which use of visible light enable different raster/pattern colors,
by a continuous pattern/raster over the entire interior surface of the dome/screen,
by sections or sectors having different patterns (e.g. by using different colors),
light spots,
a combination of these.

The raster/pattern can preferably be optimized to simplify the analysis of the field of view of the recoding mean(s).

Preferably, said recoding mean(s) and light source(s) is/are arranged close to the center of the antenna, telescope, aiming device or similar, so that the light source(s) and recording mean(s) has/have substantially the same position. The light source and recording means can be separate units or an integral unit.

Preferably, the pattern/raster is generated in a manner so that the field of view from the recording means toward the interior surface of the dome or a screen arranged in the dome, represents a unique pattern/raster at all times. If the positioning of antenna, telescope, aiming device or similar in relation to the dome is combined with less accurate angle measurements, the need for a unique pattern/raster is less and the patterns/rasters can be repeated.

By analyzing the field of view of the recording means, the accurate position and orientation of the recording means and with that the antenna, telescope, aiming device or similar can be established. This is due to that the accurate direction which the recording means is aiming at in relation to the dome has been established in a unique manner, and that the rotation about the axis of the aiming direction can be established in a unique manner.

In order to control telescopes or similar which require unhindered view in the line of sight, the part of the dome which is located outside the line of sight can be used by introducing a fixed offset for azimuth and elevation in calculation of correct aiming angle.

A method according to the invention can be summarized by the following steps:

a) Arranging or providing one or more patterns or rasters at an interior surface of a dome or a screen arranged in the dome, by means of one or more light sources,

b) Recording the patterns/rasters by means of one or more recording means,

c) Analyzing the recorded patterns/rasters,

d) Calculating the accurate position orientation of the recording means and also for the antenna, telescope, aiming device or similar, and in this way provide highly accurate position determination of aiming direction of the antenna, telescope, aiming device or similar,

e) Using position determination of aiming direction from step d) to control the antenna, telescope, aiming device or similar in relation to desired target, orbit or polarization angle.

Further advantageous features and details of the present invention will appear from the following example description.

### EXAMPLE

The present invention will in the following be described in more detail by reference to the attached drawings, where

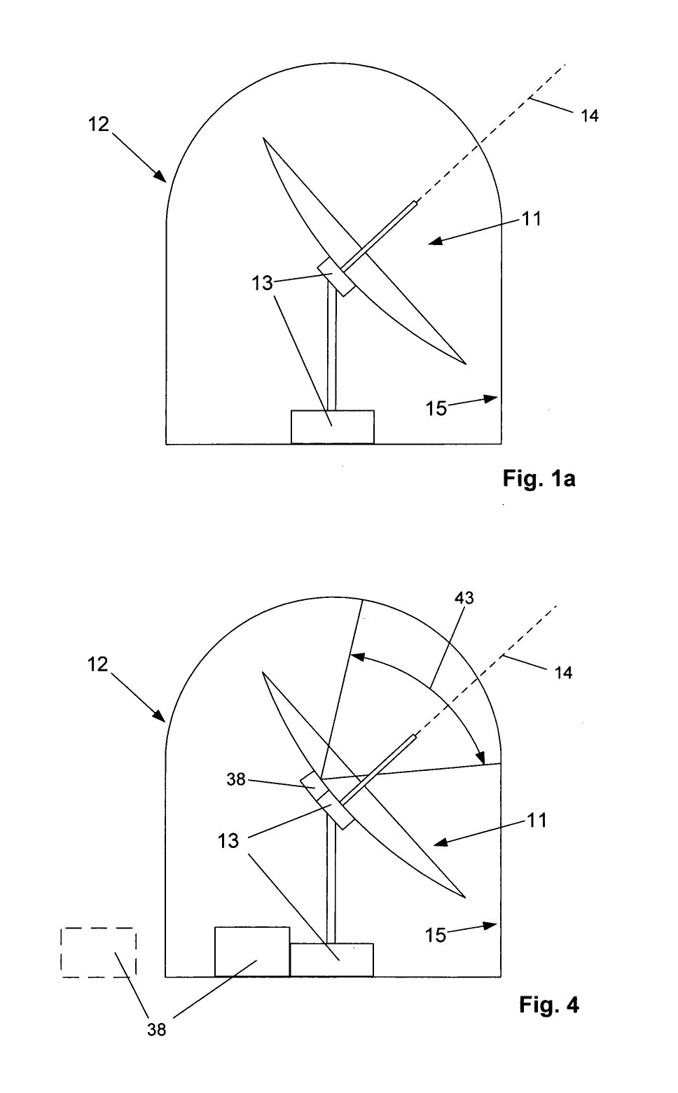

FIG. 1 is a principle drawing of an antenna arranged in a dome,

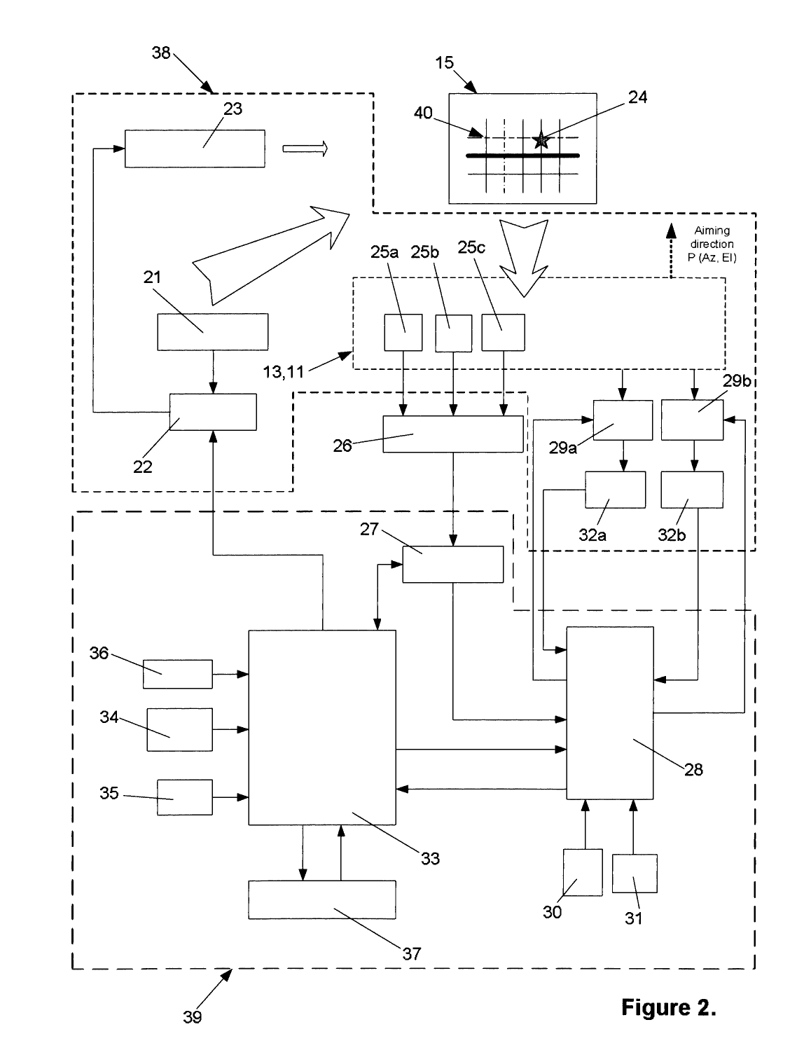

FIG. 2 is a schematic principle drawing of a system according to the invention,

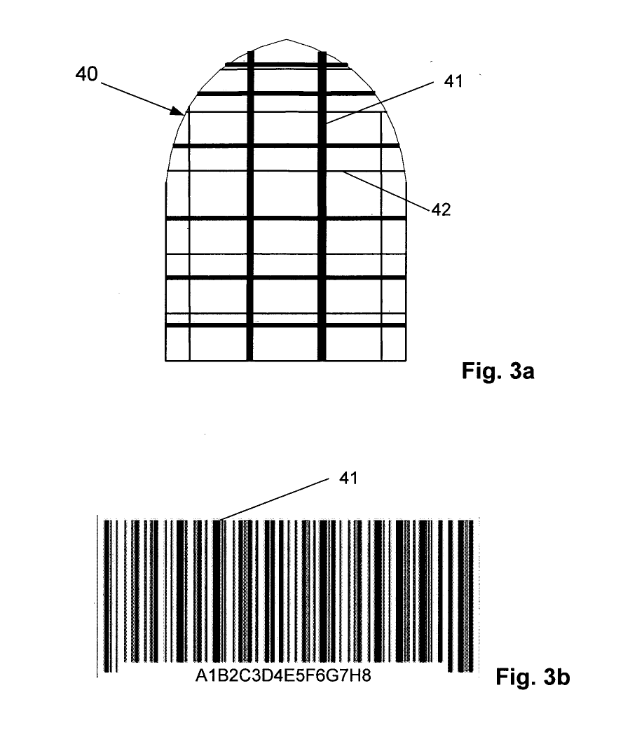

FIGS. 3a-d illustrate different rasters or patterns which can be arranged or provided at the interior surface of the dome or a screen arranged in the dome, and

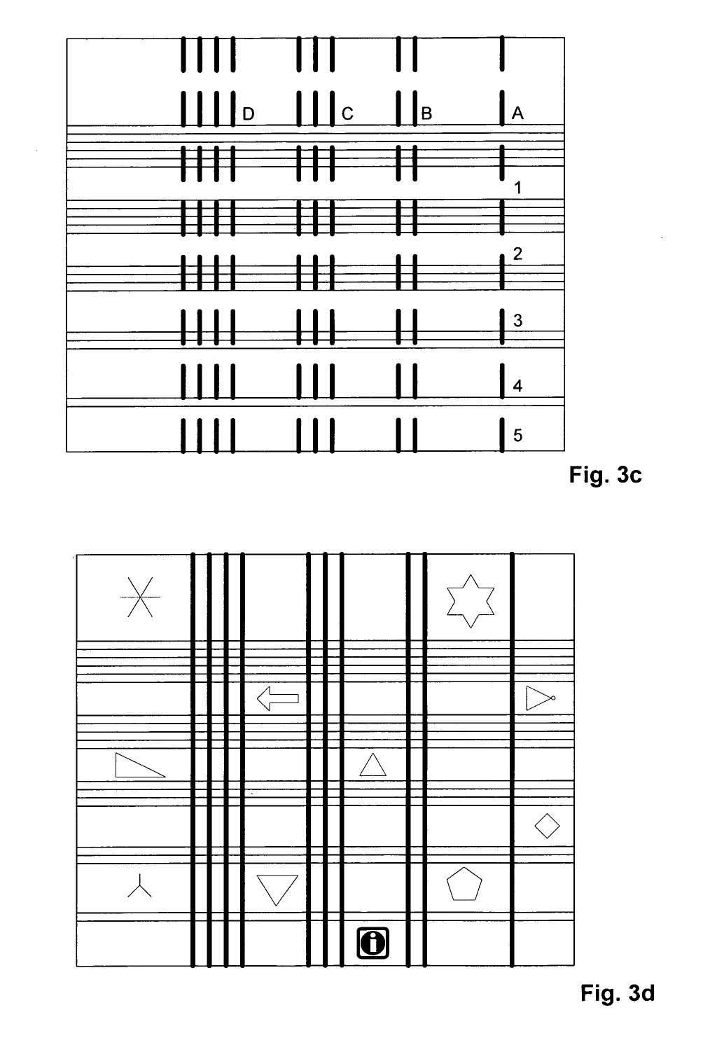

FIG. 4 is a principle drawing of a system according to the invention arranged to an antenna in a dome.

Now referring to FIG. 1, which is a principle drawing of an antenna 11 arranged in a dome 12, said antenna 11 being arranged to a movable platform 13 to control of this in azimuth and elevation. Aiming direction 14 of an antenna is determined by position in azimuth and elevation, respectively, (P(azimuth, elevation)). The antenna 11 is usually arranged to be rotated 360 degrees inside the dome 12. The main function of the dome 12 is to protect the antenna 11 against weather and wind.

Now referring to FIG. 2, which is a schematic principle drawing of a system according to the invention for arrangement in a dome 12 and where an antenna 11 is arranged on a movable platform 13 to be moved in azimuth and elevation. The figure also illustrates the flow of signals and data in the system.

A system according to the invention includes one or more light sources in the form of e.g. a projector 21 being arranged to provide one or more predefined rasters or patterns 40 (see FIGS. 3a-d) at a screen (not illustrated) arranged in the dome 12, or on an interior surface 15 (FIGS. 1 and 4) of the dome 12. Moreover, the system includes a raster or pattern control unit 22 which is arranged to select between a number of relevant rasters or patterns 40 and being connected to a control unit 33 of the system. The light source can be arranged to provide the raster or pattern 40 by means of visible and/or invisible light.

Advantageously, the system does also include a light source reference position unit 23 which is able to define a reference point 24 at the screen arranged in the dome 12 or the interior surface 15 of the dome 12, where the exact position of the reference point 24 can be controlled by the raster or pattern control unit 22.

Moreover, the system includes one or more recording means 25a-c, in the example a camera, which is/are arranged to the movable antenna 11 and which is/are moving together with this and providing possibility of stereoscopic reading of one or more rasters and/or patterns 40 provided at the screen or the interior surface 15 of the dome 12. As illustrated in FIG. 2, the camera(s) 25a-c will then follow the movements of the antenna 11 and hence the movements of the movable platform 13.

Preferably, the recording mean(s) 25a-c and light source(s) 21 is/are arranged close to the center of the antenna 11, so that the light source(s) 21 and recording mean(s) 25a-c have substantially the same position, but this is not a requirement.

Moreover, the system includes an image analyzer 26 provided with different filters arranged to transform camera signals to digital signatures and parameterized presentations of the image content from each individual camera 25a-c.

The system also includes a raster or pattern recognition unit 27 which is arranged to process the signal information from each individual camera 25a-c and transfer the relevant information to the system control unit 33 for further processing.

Moreover, the system includes a position control unit 28 arranged to control the antenna 11 position in azimuth and elevation by controlling the movable platform 13 through suitable motors and/or actuators, e.g. by means of a motor 29a for controlling azimuth and a motor 29b for controlling elevation. The position control unit 28 is preferably also provided with input about the self-motion of the system, e.g. from a MRU 30, a DP system and/or a VMM unit 31 if the antenna 11 is arranged to a vehicle or vessel in movement.

Advantageously, the system also includes position control sensors 32a-b, e.g. a sensor for azimuth and a sensor for elevation, which are arranged to measure the position of the antenna 11 in azimuth and elevation, and which can provide control signals back to the position control unit 28 and the system control unit 33. Many motors are provided with sensors like this, so that data can be acquired without the use of additional sensors as described above.

The system control unit 33 is provided with means and/or software for:
transmitting and receiving data to and from the raster or pattern recognition unit 27, position control unit 28 and remaining units 26, 32a-b, 33, 34, 35, 36, 37 of the system, described in further detail below;
performing calculations and algorithms with regard to controlling the aiming direction 14 of the antenna 11 based on data from the raster or pattern recognition unit 27, position sensors 32a-b and one or more external data sources 34, such as orbit parameters and/or orbit patterns, including control signals, typically AGC, from a receiver system 35 connected to the antenna 11, and one or more other data sources 36 with information about control of aiming direction, typically GPS, Glonass or Galileo data. Moreover, the control unit 33 is preferably provided with means and/or software for raster or pattern control, preprogramming of position and/or orbit or target, including control of the system units.

Advantageously, the system also includes a user interface 37 arranged to serve as an operator panel and being arranged to present data and provide input data to the system. The operator panel includes e.g. keyboard, mouse, joystick etc. to operate the system. The user interface 37 can for example also be a touch sensitive screen, so that the operator panel is included in the user interface.

The system can also be provided with communication means (not illustrated) to communicate with external units for remote control, so that it is not necessary to be physically present by the antenna to perform adjustments and data/information can be transmitted to the external unit in a simple manner.

Now referring to FIGS. 3a-d which show examples of a few of many different patterns or rasters 40 which can be provided at the internal surface 14 of a dome 12 or at a screen arranged in a dome 12. A raster or pattern 40 which is projected by the projector 21 can be formed either by horizontal 41 or vertical lines 42. The raster or pattern 40 can be formed by both horizontal 41 and vertical lines 42, e.g. forming a grid where the lines can be continuous or dotted, exhibit different line width or themselves forming a raster or pattern suitable for optical recognition. Examples can be bar codes, as shown in FIG. 3b, characters or numbers, as shown in FIG. 3c, figures or symbols, as shown in FIG. 3d or similar graphical codes. The raster/pattern 40 can be formed by using visible and/or invisible light. When using visible light, different colors of the pattern/raster 40 can also be used. The pattern/raster 40 can be established as a continuous pattern over the entire interior surface 15 of the dome 12/screen, or in sections or sectors having unique patterns/rasters (e.g. by using different colors). The pattern/raster 40 can also be optimized to simplify the analysis of a field of view 43 of the camera(s) 25a-d.

Reference is now made to FIG. 4 which illustrates the system according to the invention arranged to an antenna 11 arranged in a dome 12, where the system is divided in two units, a unit 38 to be arranged to the antenna 11/the movable platform 13 and a unit 39 arranged inside the dome 12 or outside the dome 12 (illustrated by dotted lines). The unit 38 (illustrated by dotted lines in FIG. 2) includes for example the units 21-26, 29a-b and 32a-b and the unit 39 (illustrated by dotted lines in FIG. 2) includes for example the units 27, 28, 30, 31 and 33-37. This is only one out of many different ways to arrange the system to an antenna 11, telescope, aiming device or similar.

The raster/pattern 40 is preferably generated in such a way that each field of view 43 of a camera toward the interior surface 15 of the dome 12 or a screen at all times represents an unique pattern/raster 40. If the positioning of the antenna in relation to the dome 12 is combined with less accurate angle measurements, the need for a unique pattern/raster is less and the patterns/rasters can be repeated. For example information about angular measurements, such as azimuth and elevation, can be provided from the sensor means 32a-b.

By analyzing the field of view 43 for each individual camera 25a-c, the accurate position and orientation of the camera(s) 25a-b can be found, and in this way also the position of the antenna 11 can be established.

This is because the accurate direction the camera(s) 25a-c is/are pointing in relation to the dome 12 is established in a unique manner, and that the rotation about the axis of the aiming direction 14 can be established in a unique way.

The rotation about the axis of the aiming direction can for example be found by analyzing horizontal lines 41 in the pattern/raster 40 and/or by using a suitable sensor in connection with the movable platform 13 for rotation of the antenna 11, and is used for controlling the polarization angle of the antenna.

A method according to the invention can be summarized by the following steps:

a) Arranging or providing one or more patterns or rasters at an interior surface of a dome or a screen arranged in the dome by means of one or more light sources,

b) Recording the patterns/rasters by means of one or more recoding means,

c) Analyzing the recorded patterns/rasters,

d) Calculating the accurate position orientation of the recording means and also for the antenna, telescope, aiming device or similar, and thereby achieve highly accurate position determination of aiming direction of the antenna, telescope, aiming device or similar,

e) Utilizing the determined position of the aiming direction from step d) to control the antenna, telescope, aiming device or similar in relation to desired target, orbit or polarization angle.

Moreover, step a) includes defining a reference point at the screen or the interior surface of the dome.

Step b) includes recording the pattern or raster located within a field of view of the recording means. This also includes patterns or rasters which can be arranged to the interior surface of the dome or screen in advance.

Step b) includes collection of information from external data sources, such as orbit parameters and/or orbit patterns, control signals from a receiver system, e.g. AGC, and from GPS, Glonass or Galileo data. Step b) also includes collection of information from position control sensors or directly from motors or actuators for control of the movable platform for information about elevation and azimuth.

Information/data from external sources are used to calculate correct position for aiming angle of the antenna in azimuth and elevation. The actual position is calculated by means of the grid of the dome. The difference between actual position and calculated position are used for control of motor operation, i.e. the motors 29a-b for aiming direction in azimuth and elevation until the deviation is minimal and within a desired tolerance.

Step d) includes calculation of accurate position of aiming direction based on information from step b) and step c). Accurate positioning in relation to aiming angle in azimuth and elevation is achieved by means of optical reading of marked position in the pattern or raster, and by processing of the image information. The actual position for line of sight is depicted at the inside of the dome by means of a laser. The laser point will thus be at a location in the pattern or raster inside the dome or at the screen, and the actual position can be read as the position of the laser point referred to the pattern or raster. As the pattern or raster can be made as long as the interior periphery of the dome, and the laser point in practice will have a very small size, the accuracy of the reading will be extremely high. By using a high-resolution camera for recording of the pattern or raster and the position of the laser point, the accuracy in the principle will be in the same order as the dispersion of the laser point at the inside of the dome.

Moreover, the method includes optimization of the arranged or provided pattern or raster for simplified analysis. The accuracy of the method is dependent of the length, height, and line and possibly symbol distance of the dome pattern. For some applications where there are requirements for rapid response time, there can be a need for developing special patterns or raster having other characteristics than pure grids. Actual variants can be bar codes or other codes which have a structure which is optimally adapted to the actual application.

By means of the invention, a system and a method has been achieved which is accurate, flexible and which in a simple manner makes it possible to use an integration of several methods, such as direct control, AGC control, orbit control etc.

### MODIFICATIONS

Said pattern or raster can also be arranged to the dome in advance, e.g. by painting it onto the interior surface of the dome or to the screen. It may also be an alternative to have a painted basic pattern/raster and apply new patterns on top by means of the light source(s).

A pattern or raster does not need to be painted on the interior surface of the dome or screen, but the screen or dome can for example be provided with fixed light sources, e.g. LED lamps, which provide light spots that define a raster or pattern, e.g. a grid.

This illustrates that there are many ways of providing the pattern or raster at the screen or dome.

The light source(s) and recording means can be a combined unit which handles both.

Numerous light sources can be used, such as lasers, projectors and other that are controllable to emit different patterns/rasters. The light source can also be provided with different filters or different optical devices to diffract a light beam to a desired pattern.

The provided pattern/raster can be used for calibration of other sensors related to an arrangement of an antenna, telescope, aiming device or similar arranged in a dome or a part of a dome, such as MRU, Gyro etc.

1. Method for positioning an antenna (11), telescope or aiming device, arranged to a movable platform (13) in a dome (12) or a part of a dome (12), said dome (12) having an interior surface (15) and/or is provided with a screen, characterized in that it includes the following steps:
a) Arranging or providing one or more patterns (40) or rasters at an interior surface (15) of a dome (12) or a screen arranged in the dome (12),
b) Recording the patterns/rasters (40) by means of one or more recording means (25a-c),
c) Analyzing the recorded patterns/rasters (40) by means of an image analyzer (26) for transforming the signals from the recording means (25a-c) to digital signatures and parametrical presentations of the image content from each individual recording means (25a-c), and a raster or pattern recognition unit (27) for signal processing the information from each individual recording means (25a-c),
d) Calculating the accurate position orientation of the recording means (25a-c) and also for the antenna (11), telescope or aiming device, and thereby achieving highly accurate position determination of aiming direction (14) of the antenna (11), telescope or aiming device,
e) Using the position determination of aiming direction (14) from step d) to control the antenna (11), telescope or aiming device in relation to desired target, orbit or polarization angle.

2. Method according to claim 1, characterized in that step a) includes the step of defining a reference point (24) at the screen or the interior surface of the dome (12).

3. Method according to claim 1, characterized in that step b) includes recording one or more patterns (40) or rasters located within a field of view (43) for each individual recording means (25a-c).

4. Method according to claim 3, characterized in that it further includes recording one or more patterns (40) or rasters arranged to the interior surface (15) of the dome (12) or screen in advance.

5. Method according to claim 1, characterized in that step b) includes collection of information from external data sources (34), such as orbit parameters and/or orbit patterns, control signals from a receiver system for e.g. AGC, and GPS, Glonass or Galileo data.

6. Method according to claim 1, characterized in that step b) in addition includes collection of information from position control sensors (32a-b) or directly from motors (29a-b) or actuators for control of the movable platform (13) for information about elevation and azimuth.

7. Method according to claim 1, characterized in that step d) includes calculating accurate position of aiming direction (14) based on information from steps b) and c).

8. Method according to claim 1, characterized in that the method includes optimizing one or more arranged or provided patterns (40) or rasters for simplified analysis.

9. System for positioning an antenna (11), telescope or aiming device arranged to a movable platform (13) in a dome (12) or a part of a dome (12), said dome (12) including an interior surface (15), said system including motors (29a-b) for controlling the movable platform (13), and position control sensors (32a-b) for collecting information about elevation and azimuth, characterized in that the system includes
one or more light sources (21) arranged to arrange or provide one or more patterns (40) or rasters at the interior surface (15) of the dome (12) or a screen arranged in the dome (12), and/or
one or more patterns (40) or rasters arranged to the interior surface (15) of the dome or a screen arranged in the dome (12) in advance by paint or fixed arranged light sources,
and one or more recording means (25a-c) arranged for stereoscopic reading of the rasters or patterns (40) provided or arranged at the interior surface (15) or the screen.

10. System according to claim 9, characterized in that the light source(s) (21) is/are arranged to emit visible and/or invisible light.

11. System according to claim 9, characterized in that the system includes a raster or pattern control unit (22) arranged for selection of relevant patterns (40).

12. System according to claim 9, characterized in that the system includes a light source reference position unit (23) arranged for defining a reference point (24) at the screen or the interior surface (15) of the dome (12).

13. System according to claim 9, characterized in that the system includes an image analyzer (26) provided with different filters and being arranged to transform the signals from the recording means (25a-c) to digital signatures and parameterized presentations of image content from each individual recording means (25a-c).

14. System according to claim 9, characterized in that the system includes a raster or pattern recognition unit (27) arranged for signal treatment of the information from each individual recording means (25a-c) and transmission of relevant information to a control unit (33) of the system for further processing.

15. System according to claim 9, characterized in that the system includes a position control unit (28) arranged for controlling the position of the antenna (11), telescope or aiming device.

16. System according to claim 15, characterized in that the system includes one or more MRUs (30), a DP system and/or VMM system (31) arranged to provide information to the position control unit (28) about the self-motion of the system.

17. System according to claim 9, characterized in that the system includes a control unit (33) provided with means and/or software for:
transmitting and receiving data and signals from the raster or pattern recognition unit (27), position control unit (28) and remaining units (26, 32a-b, 33, 34, 35, 36, 37) of the system;
performing calculations and algorithms with regard to controlling and control of aiming direction (14) for the antenna (11), telescope or aiming device.

18. System according to claim 17, characterized in that the control unit (33) further is provided with means and/or software for raster or pattern control, preprogramming of position and/or orbit or target including control of the system units.

19. System according to claim 9, characterized in that the system includes a user interface (37) arranged for presentation of data and input of data to the system.

20. System according to claim 9, characterized in that the measuring devices (25a-c) are arranged for stereoscopic reading of said one or more rasters or patterns (40) provided or arranged at the interior surface (15) of the dome (12) or screen within a defined field of view (43) for each recording means (25a-c).

21. System according to claim 9, characterized in that the light source(s) (21) and recording means (25a-c) is/are arranged to the antenna (11), telescope or aiming device close to the center of the antenna (11), telescope or aiming device.

22. System according to claim 9, characterized in that the interior surface (15) of the dome (12) or screen is provided with one or more pre-produced patterns (40) or rasters.

23. System according to claim 9, characterized in that the raster or pattern (40) is formed:
by either horizontal or vertical lines,
by both horizontal and vertical lines,
by bar codes, characters, figures, symbols or similar graphic codes,
by lines having different properties,
by lines which themselves form a pattern suitable for optical recognition,
by use of visible and/or invisible light,
by a continuous pattern/raster over the entire interior surface of the dome/screen,
by sections or sectors having different patterns,
by light spots,
by a combination of these.

24. System according to claim 9, characterized in that the system is provided with communication means (not illustrated) for communication with external units.
